(19) United States
(12) Patent Application Publication
(10) Pub. No.: US 2006/0231197 A1
(43) Pub. Date: Oct. 19, 2006

(54) LAMINATED PLATE MATERIAL HAVING NATURAL TEXTURE AND METHOD OF MANUFACTURING THEREOF

(75) Inventor: Masahiro HOSAKA, Kasugai-shi, Aichi (JP)

Correspondence Address: SUGHRUE MION, PLLC, 2100 PENNSYLVANIA AVENUE, N.W., SUITE 800, WASHINGTON, DC, 20037, US

(73) Assignee: BISHU-LUMBER INDUSTRY LTD., Kasugai-shi, Aichi (JP)

(21) Appl. No.: 11/276,279

(22) Filed: Feb. 22, 2006

(30) Foreign Application Priority Data
Feb. 23, 2005 (JP) 2005-046539

(51) Int. Cl. B32B 37/12; B32B 38/04; B32B 21/04

(52) U.S. Cl. 156/250; 428/535; 428/537.1; 156/264

(57) ABSTRACT

There is developed a method of obtaining a natural-texture laminated plate material having colors or textures of grains of a plate material obtained from a natural large-diameter tree such as ebony, red sandalwood, Chinese quince, cheek, maple, ash, or oak by use of a wood which can be cyclically produced in a short cycle in an artificial forest of paulownia, poplar, Radiata pine, whitewood, rubber or the like. There is provided a method of manufacturing a laminated plate material having a natural texture, in which small blocks of a wood cyclically produceable in an artificial forest are immersed into a solution of a coloring agent, the blocks are removed in a stage where winter grains are completely colored and summer grains are being colored, straight grains are aligned to bond the blocks to one another, thereby forming the laminated plate material, and there is obtained the natural-texture laminated plate material having a natural appearance in which the winter grains are deeply colored and the summer grains are lightly colored.

### INCORPORATION BY REFERENCE

The present application claims the priority of Japanese Patent Application No. 2005-46539 filed on Feb. 23, 2005, and incorporates herein the contents with reference thereto.

### BACKGROUND OF THE INVENTION

1. Field of the Invention

The present invention relates to a method of manufacturing a plate material having a natural texture which is similar to that of a plate material lumbered from a natural large-diameter tree having a high scarcity value, such as ebony, red sandalwood, Chinese quince, cheek, maple, ash, or oak by use of a wood which can be cyclically produced in a short cycle in an artificial forest of paulownia, poplar, Radiata pine, whitewood, rubber or the like. The present invention also relates to a natural-texture plate material manufactured by the method.

2. Description of the Related Art

A plate material lumbered from a natural large-diameter tree such as ebony, red sandalwood, Chinese quince, cheek, maple, ash, or oak provides a feeling of luxury and enjoys popularity, but these trees take much time to grow, and cannot be supplied by plantation. Therefore, in recent years, chances to put the plate material on the market have decreased, and the plate material of this type of large-diameter tree has not been used in general manufacturing of architecture or furniture for a long time. The Yakushima cedar of the Yakushima island, beech of the Shirakami mountain range, the Taiwanese cypress of Taiwan and the like are designated as world heritages by the UNESCO, they are prohibited from being felled by the country, and it is impossible to use the plate material as a material for the architecture or the furniture.

It is difficult to use the Yakushima cedar, the beach of the Shirakami mountain range, the Taiwanese cypress of Taiwan or the like, but there is a strong demand for the feeling of luxury brought about by the plate material lumbered from a natural large-diameter tree such as ebony, red sandalwood, Chinese quince, cheek, maple, ash, or oak. To meet the demand, various devises have been made. For example, there is a method of printing and reproducing grains of the above type of large-diameter tree to attach the grains to the furniture or the architecture. This method and the like are remarkably easy, but is often performed. However, since the printed grains apparently compare poorly, the method has been seldom used in recent years.

Moreover, attempts have been made to lumber a plate material from a tree which comparatively inexpensively grows fast and which can be sufficiently supplied by the plantation. In this case, for example, to assimilate the plate material to that of the ebony, the material is colored with a black pigment or dyestuff. However, in the conventional method, the whole manufactured plate material is homogeneously colored in black, a texture of the material is far different from that of the ebony, and the only black plate material can simply be obtained. This also applies to a method of obtaining a plate material similar to that of red sandalwood, Chinese quince, cheek, maple, ash, or oak. The simply colored plate material can only be obtained which is still far different from a genuine material.

That is, the conventional method has focused on obtaining a coloring method in which there is as little color unevenness as possible. As a result, it may be said that a result far different from a texture owned by a natural large-diameter tree could only be derived. As an example of the invention relating to the homogeneous coloring method providing the color unevenness as little as possible, there is introduced a method described in JP-A-2001-1308. In JP-A-2004-52492, there is described a method of printing and adding grains.

### SUMMARY OF THE INVENTION

In view of the above-described situations, an object of the present invention is to develop a method of manufacturing a laminated plate material having a natural texture which is similar to that of a plate material manufactured from a natural large-diameter tree having a high scarcity value, the tree including ebony, red sandalwood, Chinese quince, cheek, maple, ash, or oak by use of a wood which can be cyclically produced in a short cycle in an artificial forest of paulownia, poplar, Radiata pine, whitewood, rubber or the like. The object is also to obtain a natural-texture laminated plate material by the method. The following two problems were set in order to achieve this object.

<Problem 1>

As to the wood which can be cyclically produced in a short cycle in an artificial forest of paulownia, poplar, Radiata pine, whitewood, rubber or the like, the tree seldom becomes large like a tree such as ebony, red sandalwood, Chinese quince, cheek, maple, ash, or oak. Therefore, the first problem is to develop a method of obtaining a plate material having a large width and having a consistency of grains even from a small-diameter tree as if the grains were taken from the large-diameter tree.

<Problem 2>

The second problem is to develop a coloring method for bringing a grain color or texture of a plate material as close as possible to that of a plate material obtained from a large-diameter tree such as ebony, red sandalwood, Chinese quince, cheek, maple, ash, or oak in a case where the plate material is colored which has been taken from a wood cyclically produceable in a short cycle in an artificial forest of paulownia, poplar, Radiata pine, whitewood, rubber or the like.

The present invention has been developed to solve the above problems, and provides the following solution means.

<Solution Means 1>

A method of manufacturing a laminated plate material having a natural texture, comprising the steps of:

lumbering a wood which is cyclically produceable in an artificial forest to obtain a plurality of rectangular parallelepiped wood blocks having faces on which straight grains appear in a longitudinal direction;

immersing the respective wood blocks obtained in the above step into a solution of a coloring agent dissolved and liquefied in a solvent;

removing the respective immersed wood blocks from the solution of the coloring agent in a stage in which winter grains are completely colored and summer grains are in process of coloring; and

assembling the respective wood blocks removed from the solution of the coloring agent so as to bring to tops the faces on which the straight grains appear, bonding adjacent sides of the blocks to one another with an adhesive, whereby the natural-texture laminated plate material having such a natural appearance that the winter grains are deeply colored and the summer grains are lightly colored is obtained.

<Solution Means 2>

A method of manufacturing a laminated plate material having a natural texture, comprising the steps of:

lumbering a wood which is cyclically produceable in an artificial forest to obtain a plurality of rectangular parallelepiped wood blocks having faces on which straight grains appear in a longitudinal direction;

immersing the respective wood blocks obtained in the above step into a solution of a coloring agent dissolved and liquefied in a solvent;

removing the respective immersed wood blocks from the solution of the coloring agent in a stage in which winter grains are completely colored and summer grains are in process of coloring; and

assembling the respective wood blocks removed from the solution of the coloring agent so as to bring to a top a face of one of the wood blocks on which flat grains appear and bring to tops the faces of the remaining wood blocks on which the straight grains appear, bonding adjacent sides of the blocks to one another with an adhesive, whereby the natural-texture laminated plate material having such a natural appearance that the winter grains are deeply colored and the summer grains are lightly colored is obtained.

<Solution Means 3>

A method of manufacturing a laminated plate material having a natural texture, comprising the steps of:

lumbering a wood which is cyclically produceable in an artificial forest to obtain a plurality of rectangular parallelepiped wood blocks having faces on which straight grains appear in a longitudinal direction;

immersing the respective wood blocks obtained in the above step into a solution of a coloring agent dissolved and liquefied in a solvent;

removing the respective immersed wood blocks from the solution of the coloring agent in a stage in which winter grains are completely colored and summer grains are in process of coloring;

assembling the respective wood blocks removed from the solution of the coloring agent so as to bring to tops the faces on which the straight grains appear, bonding adjacent sides of the blocks to one another with an adhesive, and obtaining the natural-texture laminated plate material having such a natural appearance that the winter grains are deeply colored and the summer grains are lightly colored; and

slicing or lumbering the resultant natural-texture laminated plate material in parallel with the top of the material to obtain a plurality of natural-texture laminated plate materials having such the natural appearance that the winter grains are deeply colored and the summer grains are lightly colored.

<Solution Means 4>

A method of manufacturing a laminated plate material having a natural texture, comprising the steps of:

lumbering a wood which is cyclically produceable in an artificial forest to obtain a plurality of rectangular parallelepiped wood blocks having faces on which straight grains appear in a longitudinal direction;

immersing the respective wood blocks obtained in the above step into a solution of a coloring agent dissolved and liquefied in a solvent;

removing the respective immersed wood blocks from the solution of the coloring agent, in a stage in which winter grains are completely colored and summer grains are in process of coloring;

assembling the respective wood blocks removed from the solution of the coloring agent so as to bring to a top a face of one of the wood blocks on which flat grains appear and bring to tops the faces of the remaining wood blocks on which the straight grains appear, bonding adjacent sides of the blocks to one another with an adhesive to obtain the natural-texture laminated plate material having such a natural appearance that the winter grains are deeply colored and the summer grains are lightly colored; and

slicing or lumbering the resultant natural-texture laminated plate material in parallel with the top of the material to obtain a plurality of natural-texture laminated plate materials having such the natural appearance that the winter grains are deeply colored and the summer grains are lightly colored.

<Solution Means 5>

A method of manufacturing a laminated plate material having a natural texture, comprising the steps of:

lumbering a wood which is cyclically produceable in an artificial forest to obtain a plurality of rectangular parallelepiped wood blocks having faces on which straight grains appear in a longitudinal direction;

assembling the respective wood blocks obtained in the above step so as to bring to tops the faces on which the straight grains appear, bonding adjacent sides of the blocks to one another with an adhesive, and obtaining a laminated plate material;

slicing or lumbering the laminated plate material obtained in the second step in parallel with the top of the material to obtain a plurality of laminated plate materials;

immersing the respective laminated plate materials obtained in the third step into a solution of a coloring agent dissolved and liquefied in a solvent; and

removing the respective immersed laminated plate materials from the solution of the coloring agent in a stage in which winter grains are completely colored and summer grains are in process of coloring, whereby natural-texture laminated plate materials having such natural appearances that the winter grains are deeply colored and the summer grains are lightly colored is obtained.

<Solution Means 6>

A method of manufacturing a laminated plate material having a natural texture, comprising the steps of:

lumbering a wood which is cyclically produceable in an artificial forest to obtain a plurality of rectangular parallelepiped wood blocks having faces on which straight grains appear in a longitudinal direction;

assembling the respective wood blocks obtained in the above step so as to bring to a top a face of one of the wood blocks on which flat grains appear and bring to tops the faces of the remaining wood blocks on which the straight grains appear, bonding adjacent sides of the blocks to one another with an adhesive, and obtaining a laminated plate material;

slicing or lumbering the laminated plate material obtained in the second step in parallel with the top of the material to obtain a plurality of laminated plate materials;

immersing the respective laminated plate materials obtained in the third step into a solution of a coloring agent dissolved and liquefied in a solvent; and

removing the respective immersed laminated plate materials from the solution of the coloring agent in a stage in which winter grains are completely colored and summer grains are in process of coloring to obtain natural-texture laminated plate materials having such natural appearances that the winter grains are deeply colored and the summer grains are lightly colored.

<Solution Means 7>

A method of manufacturing a laminated plate material having a natural texture, comprising the steps of:

lumbering a wood which is cyclically produceable in an artificial forest to obtain a plurality of rectangular parallelepiped wood blocks having faces on which straight grains appear in a longitudinal direction;

immersing the respective wood blocks obtained in the above step into a solution of a coloring agent dissolved and liquefied in a solvent;

removing the respective immersed wood blocks from the solution of the coloring agent in a stage in which both of winter and summer grains are completely colored;

assembling the respective removed wood blocks so as to bring to tops the faces of the respective wood blocks on which the straight grains appear, peeling layers in which both of the winter and summer grains are completely colored from adjacent sides of the blocks and thereafter bonding the adjacent sides to one another with an adhesive to obtain a laminated plate material in which both of the winter and summer grains are completely colored; and

peeling the surface of the laminated plate material obtained in the fourth step until a face appears on which the winter grains are completely colored and the summer grains are being colored, and obtaining the natural-texture laminated plate material having such a natural appearance that the winter grains are deeply colored and the summer grains are lightly colored.

<Solution Means 8>

A method of manufacturing a laminated plate material having a natural texture, comprising the steps of:

lumbering a wood which is cyclically produceable in an artificial forest to obtain a plurality of rectangular parallelepiped wood blocks having faces on which straight grains appear in a longitudinal direction;

immersing the respective wood blocks obtained in the above step into a solution of a coloring agent dissolved and liquefied in a solvent;

removing the respective immersed wood blocks from the solution of the coloring agent in a stage in which both of winter and summer grains are completely colored;

assembling the respective removed wood blocks so as to bring to a top a face of one of the wood blocks on which flat grains appear and bring to tops the faces of the remaining wood blocks on which the straight grains appear, peeling layers in which both of the winter and summer grains are completely colored from adjacent sides of the blocks and thereafter bonding the adjacent sides to one another to obtain a laminated plate material; and

peeling the surface of the laminated plate material obtained in the fourth step until a face appears on which the winter grains are completely colored and the summer grains are being colored, and obtaining the natural-texture laminated plate material having such a natural appearance that the winter grains are deeply colored and the summer grains are lightly colored.

<Solution Means 9>

The method of manufacturing the laminated plate material having the natural texture according to any one of the solution means 1 to 8, wherein the solution of the coloring agent is blended with an incombustible agent.

<Solution Means 10>

A natural-texture laminated plate material manufactured by the method of manufacturing the laminated plate material having the natural texture according to any one of the solution means 1 to 9.

In the present invention, the invention of the solution means 1 is the method of manufacturing the laminated plate material having the natural texture, comprising the steps of: lumbering the wood which is cyclically produceable in the artificial forest to obtain the plurality of rectangular parallelepiped wood blocks having the faces on which the straight grains appear in the longitudinal direction; immersing the respective wood blocks obtained in the above step into the solution of the coloring agent dissolved and liquefied in the solvent; removing the respective immersed wood blocks from the solution of the coloring agent in the stage in which the winter grains are completely colored and the summer grains are in process of coloring; and assembling the respective wood blocks removed from the solution of the coloring agent so as to bring to the tops the faces on which the straight grains appear, bonding the adjacent sides of the blocks to one another with the adhesive, and obtaining the natural-texture laminated plate material having such the natural appearance that the winter grains are deeply colored and the summer grains are lightly colored. Therefore, it is possible to obtain from the wood which can be cyclically produced in a short cycle in the artificial forest the natural-texture comparatively thick (usually a thickness of several millimeters or more) laminated plate material having a straight-grain appearance closely akin to that of a plate material obtained by lumbering a natural large-diameter tree having a scarcity value.

In the present invention, the invention of the solution means 2 is the method of manufacturing the laminated plate material having the natural texture, comprising the steps of: lumbering the wood which is cyclically produceable in the artificial forest to obtain the plurality of rectangular parallelepiped wood blocks having the faces on which the straight grains appear in the longitudinal direction; immersing the respective wood blocks obtained in the above step into the solution of the coloring agent dissolved and liquefied in the solvent; removing the respective immersed wood blocks from the solution of the coloring agent in the stage in which the winter grains are completely colored and the summer grains are in process of coloring; and assembling the respective wood blocks removed from the solution of the coloring agent so as to bring to the top the face of one of the wood blocks on which the flat grains appear and bring to the tops the faces of the remaining wood blocks on which the straight grains appear, bonding the adjacent sides of the blocks to one another with the adhesive, and obtaining the natural-texture laminated plate material having such the natural appearance that the winter grains are deeply colored and the summer grains are lightly colored. Therefore, it is possible to obtain from the wood which can be cyclically produced in a short cycle in the artificial forest the natural-texture comparatively thick (usually a thickness of several millimeters or more) laminated plate material having a flat-grain appearance closely akin to that of a plate material obtained by lumbering a natural large-diameter tree having a scarcity value.

In the present invention, the invention of the solution means 3 is the method of manufacturing the laminated plate material having the natural texture, comprising the steps of: lumbering the wood which is cyclically produceable in the artificial forest to obtain the plurality of rectangular parallelepiped wood blocks having the faces on which the straight grains appear in the longitudinal direction; immersing the respective wood blocks obtained in the above step into the solution of the coloring agent dissolved and liquefied in the solvent; removing the respective immersed wood blocks from the solution of the coloring agent in the stage in which the winter grains are completely colored and the summer grains are in process of coloring; assembling the respective wood blocks removed from the solution of the coloring agent so as to bring to the tops the faces on which the straight grains appear, bonding the adjacent sides of the blocks to one another with the adhesive, and obtaining the natural-texture laminated plate material having such the natural appearance that the winter grains are deeply colored and the summer grains are lightly colored; and slicing or lumbering the resultant natural-texture laminated plate material in parallel with the top of the material to obtain the plurality of natural-texture laminated plate materials having such the natural appearance that the winter grains are deeply colored and the summer grains are lightly colored. Therefore, it is possible to obtain from the wood which can be cyclically produced in a short cycle in the artificial forest the natural-texture comparatively thin (a thickness of 0.2 mm to about several millimeters) laminated plate material having a straight-grain appearance closely akin to that of a plate material obtained by lumbering a natural large-diameter tree having a scarcity value.

In the present invention, the invention of the solution means 4 is the method of manufacturing the laminated plate material having the natural texture, comprising the steps of: lumbering the wood which is cyclically produceable in the artificial forest to obtain the plurality of rectangular parallelepiped wood blocks having the faces on which the straight grains appear in the longitudinal direction; immersing the respective wood blocks obtained in the above step into the solution of the coloring agent dissolved and liquefied in the solvent; removing the respective immersed wood blocks from the solution of the coloring agent in the stage in which the winter grains are completely colored and the summer grains are in process of coloring; assembling the respective wood blocks removed from the solution of the coloring agent so as to bring to the top the face of one of the wood blocks on which the flat grains appear and bring to the tops the faces of the remaining wood blocks on which the straight grains appear, bonding the adjacent sides of the blocks to one another with the adhesive, whereby the natural-texture laminated plate material having such the natural appearance that the winter grains are deeply colored and the summer grains are lightly colored is obtained; and slicing or lumbering the resultant natural-texture laminated plate material in parallel with the top of the material to obtain the plurality of natural-texture laminated plate materials having such the natural appearance that the winter grains are deeply colored and the summer grains are lightly colored. Therefore, it is possible to obtain from the wood which can be cyclically produced in a short cycle in the artificial forest the natural-texture comparatively thin (a thickness of 0.2 mm to about several millimeters) laminated plate material having a flat-grain appearance closely akin to that of a plate material obtained by lumbering a natural large-diameter tree having a scarcity value.

In the present invention, the invention of the solution means 5 is the method of manufacturing the laminated plate material having the natural texture, comprising the steps of: lumbering the wood which is cyclically produceable in the artificial forest to obtain the plurality of rectangular parallelepiped wood blocks having the faces on which the straight grains appear in the longitudinal direction; assembling the respective wood blocks obtained in the above step so as to bring to the tops the faces on which the straight grains appear, bonding the adjacent sides of the blocks to one another with the adhesive, and obtaining the laminated plate material; slicing or lumbering the laminated plate material obtained in the second step in parallel with the top of the material to obtain the plurality of laminated plate materials; immersing the respective laminated plate materials obtained in the third step into the solution of the coloring agent dissolved and liquefied in the solvent; and removing the respective immersed laminated plate materials from the solution of the coloring agent in the stage in which the winter grains are completely colored and the summer grains are in process of coloring, whereby the natural-texture laminated plate materials having such natural appearances that the winter grains are deeply colored and the summer grains are lightly colored is obtained. Therefore, it is possible to obtain from the wood which can be cyclically produced in a short cycle in the artificial forest the natural-texture comparatively thin (a thickness of 0.2 mm to several millimeters) laminated plate material having a straight-grain appearance closely akin to that of the plate material obtained by lumbering the natural large-diameter tree having the scarcity value.

In the present invention, the invention of the solution means 6 is the method of manufacturing the laminated plate material having the natural texture, comprising the steps of: lumbering the wood which is cyclically produceable in the artificial forest to obtain the plurality of rectangular parallelepiped wood blocks having the faces on which the straight grains appear in the longitudinal direction; assembling the respective wood blocks obtained in the above step so as to bring to the top the face of one of the wood blocks on which the flat grains appear and bring to the tops the faces of the remaining wood blocks on which the straight grains appear, bonding the adjacent sides of the blocks to one another with the adhesive, and obtaining the laminated plate material; slicing or lumbering the laminated plate material obtained in the second step in parallel with the top of the material to obtain the plurality of laminated plate materials; immersing the respective laminated plate materials obtained in the third step into the solution of the coloring agent dissolved and liquefied in the solvent; and removing the respective immersed laminated plate materials from the solution of the coloring agent in the stage in which the winter grains are completely colored and the summer grains are in process of coloring, whereby the natural-texture laminated plate material having such natural appearances that the winter grains are deeply colored and the summer grains are lightly colored is obtained. Therefore, it is possible to obtain from the wood which can be cyclically produced in a short cycle in the artificial forest the natural-texture comparatively thin (a thickness of 0.2 mm to about several millimeters) laminated plate material having a flat-grain appearance closely akin to that of a plate material obtained by lumbering a natural large-diameter tree having a scarcity value.

In the present invention, the invention of the solution means 7 is the method of manufacturing the laminated plate material having the natural texture, comprising the steps of: lumbering the wood which is cyclically produceable in the artificial forest to obtain the plurality of rectangular parallelepiped wood blocks having the faces on which the straight grains appear in the longitudinal direction; immersing the respective wood blocks obtained in the above step into the solution of the coloring agent dissolved and liquefied in the solvent; removing the respective immersed wood blocks from the solution of the coloring agent in the stage in which both of the winter and summer grains are completely colored; assembling the respective removed wood blocks so as to bring to the tops the faces of the respective wood blocks on which the straight grains appear, peeling the layers in which both of the winter and summer grains are completely colored from the adjacent sides of the blocks before bonding the adjacent sides to one another with the adhesive, and obtaining the laminated plate material in which both of the winter and summer grains are completely colored; and peeling the surface of the laminated plate material obtained in the fourth step until the face appears on which the winter grains are completely colored and the summer grains are being colored, and obtaining the natural-texture laminated plate material having such the natural appearance that the winter grains are deeply colored and the summer grains are lightly colored. Therefore, it is possible to obtain from the wood which can be cyclically produced in a short cycle in the artificial forest the natural-texture comparatively thick (usually a thickness of several millimeters or more) laminated plate material having a straight-grain appearance closely akin to that of a plate material obtained by lumbering a natural large-diameter tree having a scarcity value. It is to be noted that, needless to say, it is possible to further slice or lumber the laminated plate material obtained by this method, thereby obtaining a comparatively thin (a thickness of 0.2 mm to about several millimeters) laminated plate material.

In the present invention, the invention of the solution means 8 is the method of manufacturing the laminated plate material having the natural texture, comprising the steps of: lumbering the wood which is cyclically produceable in the artificial forest to obtain the plurality of rectangular parallelepiped wood blocks having the faces on which the straight grains appear in the longitudinal direction; immersing the respective wood blocks obtained in the above step into the solution of the coloring agent dissolved and liquefied in the solvent; removing the respective immersed wood blocks from the solution of the coloring agent in the stage in which both of the winter and summer grains are completely colored; assembling the respective removed wood blocks so as to bring to the top the face of one of the wood blocks on which the flat grains appear and bring to the tops the faces of the remaining wood blocks on which the straight grains appear, peeling the layers in which both of the winter and summer grains are completely colored from the adjacent sides of the blocks before bonding the adjacent sides to one another, and obtaining the laminated plate material; and peeling the surface of the laminated plate material obtained in the fourth step until the face appears on which the winter grains are completely colored and the summer grains are being colored, and obtaining the natural-texture laminated plate material having such the natural appearance that the winter grains are deeply colored and the summer grains are lightly colored. Therefore, it is possible to obtain from the wood which can be cyclically produced in a short cycle in the artificial forest the natural-texture comparatively thick (usually a thickness of several millimeters or more) laminated plate material having a flat-grain appearance closely akin to that of a plate material obtained by lumbering a natural large-diameter tree having a scarcity value. It is to be noted that, needless to say, it is possible to further slice or lumber the laminated plate material obtained by this method, thereby obtaining a comparatively thin (a thickness of 0.2 mm to about several millimeters) laminated plate material.

In the present invention, the invention of the solution means 9 is the method of manufacturing the laminated plate material having the natural texture according to any one of the solution means 1 to 8, wherein the solution of the coloring agent is blended with the incombustible agent. Therefore, it is possible to obtain, from the wood which can be cyclically produced in a short cycle in the artificial forest, a natural-texture highly-incombustible laminated plate material whose appearance is closely akin to that of a plate material obtained by lumbering a natural large-diameter tree having a scarcity value.

In the present invention, the invention of the solution means 10 is the natural-texture laminated plate material manufactured by the method of manufacturing the laminated plate material having the natural texture according to any one of the solution means 1 to 9. Therefore, it is possible to obtain, from a wood which can be cyclically produced in a short cycle in the artificial forest, a natural-texture laminated plate material whose appearance is closely akin to that of a plate material obtained by lumbering a natural large-diameter tree having a scarcity value. Therefore, felling of a natural large-diameter tree having a scarcity value can be reduced as much as possible, and the present invention is also useful for protection of natural environments. In addition, it is possible to remarkably inexpensively provide a natural-texture laminated plate material whose appearance is closely akin to that of a plate material obtained by lumbering the natural large-diameter tree having the scarcity value.

Other objects, characteristics, and advantages of the present invention will be apparent from the following description of embodiments of the present invention with reference to the accompanying drawings.

### BRIEF DESCRIPTION OF THE DRAWINGS

FIG. 1 is an explanatory view showing a method of Embodiment 1 of the present invention;

FIG. 2 is an explanatory view showing the method of Embodiment 1 of the present invention;

FIG. 3 is an explanatory view showing a method of Embodiment 2 of the present invention;

FIG. 4 is an explanatory view showing the method of Embodiment 2 of the present invention;

FIG. 5 is an explanatory view showing a method of Embodiment 5 of the present invention;

FIG. 6 is an explanatory view showing the method of Embodiment 1 of the present invention;

FIG. 7 is an explanatory view showing the method of Embodiment 6 of the present invention;

FIG. 8 is an explanatory view showing the method of Embodiment 2 of the present invention;

FIG. 9 is an explanatory view showing a method of Embodiment 3 of the present invention;

FIG. 10 is an explanatory view showing a method of Embodiment 4 of the present invention;

FIG. 11 is an explanatory view showing the method of Embodiment 5 of the present invention;

FIG. 12 is an explanatory view showing the method of Embodiment 6 of the present invention;

FIG. 13 is an explanatory view showing a method of Embodiment 7 of the present invention;

FIG. 14 is an explanatory view showing a method of Embodiment 8 of the present invention;

FIG. 15 is an explanatory view showing the method of Embodiments 1 to 8 of the present invention; and

FIG. 16 is an explanatory view showing the method of Embodiments 1 to 8 of the present invention.

### DESCRIPTION OF THE PREFERRED EMBODIMENTS

The best mode for carrying out the present invention will be described hereinafter in detail with reference to the drawings. Embodiment 1 is an embodiment of the invention of Solution Means 1, Embodiment 2 is an embodiment of the invention of Solution Means 2, Embodiment 3 is an embodiment of the invention of Solution Means 3, Embodiment 4 is an embodiment of the invention of Solution Means 4, Embodiment 5 is an embodiment of the invention of Solution Means 5, Embodiment 6 is an embodiment of the invention of Solution Means 6, Embodiment 7 is an embodiment of the invention of Solution Means 7, Embodiment 8 is an embodiment of the invention of Solution Means 8, and Embodiment 9 is an embodiment of the invention of Solution Means 9.

### Embodiment 1

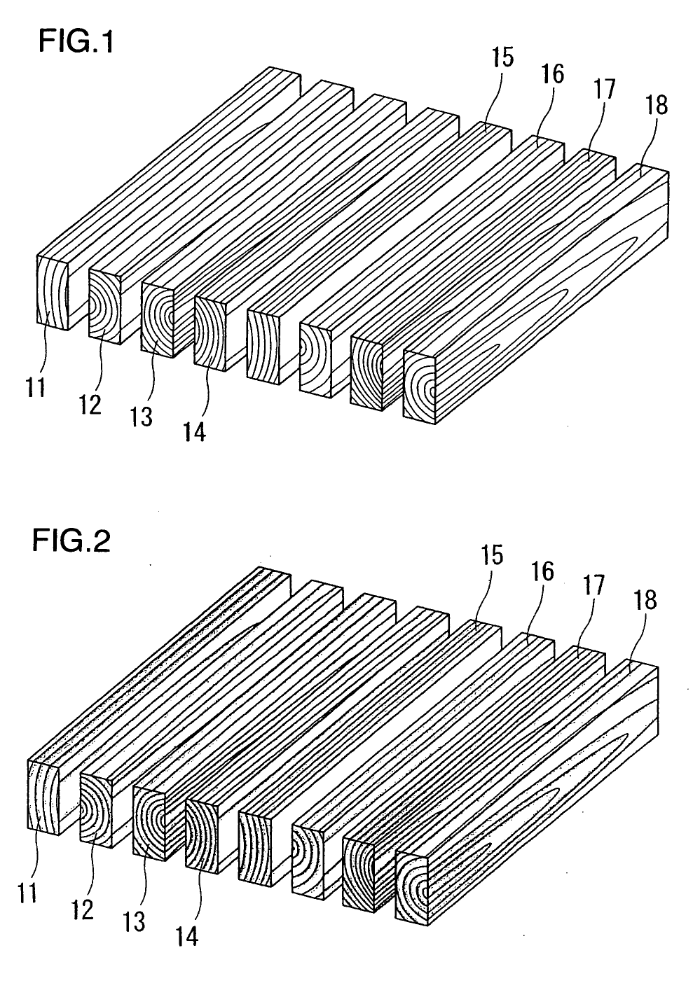

As shown in FIG. 1, there is lumbered a wood which can be cyclically produced in a short cycle in an artificial forest of paulownia, poplar, Radiata pine, whitewood, rubber or the like to obtain a plurality of rectangular parallelepiped wood blocks 11 to 18 having faces on which straight grains appear in a longitudinal direction. Next, the wood blocks 11 to 18 are immersed into a solution (not shown) of a coloring agent dissolved and liquefied in a solvent. The blocks are removed from the solution of the coloring agent in a stage in which winter grains are completely colored and summer grains are being colored. Moreover, the wood blocks 11 to 18 removed from the solution of the coloring agent are dried. As shown in FIG. 2, there are obtained the natural-texture wood blocks 11 to 18 having a natural appearance in which the winter grains are deeply colored and the summer grains are lightly colored.

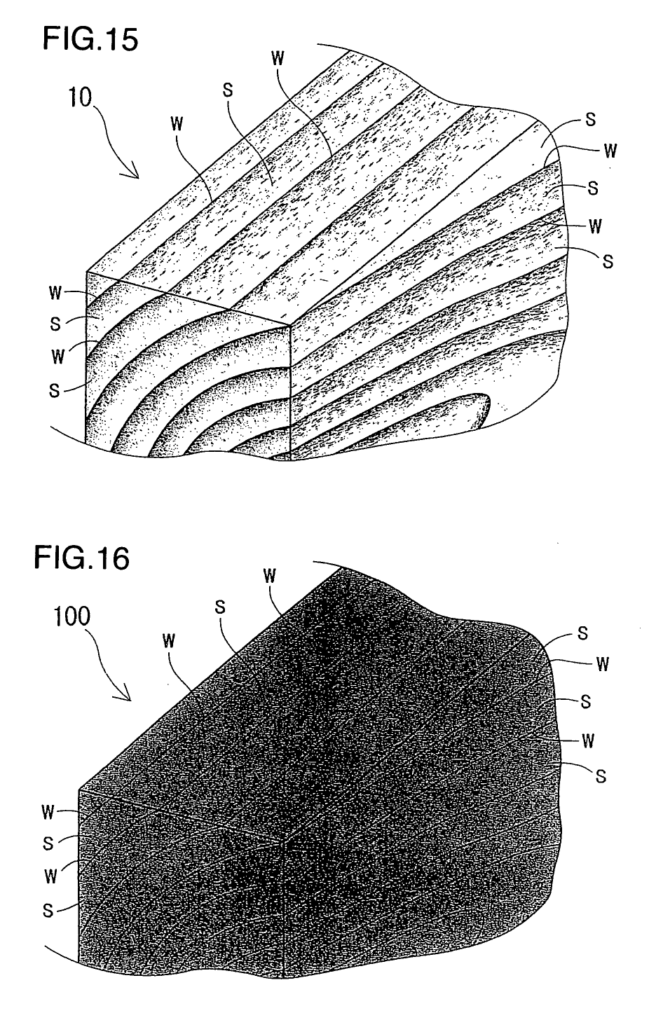

For example, an enlarged diagram of FIG. 15 shows details of the natural appearance state in which the winter grains are deeply colored and the summer grains are lightly colored. An appearance of a wood block 10 of FIG. 15 has a texture which is closely akin to that of a plate material lumbered from a natural large-diameter tree such as ebony, red sandalwood, Chinese quince, cheek, maple, ash, or oak owing to a color of the coloring agent. It is to be noted that in FIG. 15, the winter grains are denoted with symbols w, and the summer grains are denoted with symbols s.

These plurality of wood blocks 11 to 18 is assembled so as to bring to tops the faces of the respective wood blocks on which the straight grains appear, and then, adjacent sides of the blocks are bonded to one another with an adhesive. Thus, a natural-texture laminated plate material 1 (see FIG. 6) having such a natural appearance that the winter grains are deeply colored and the summer grains are lightly colored can be obtained. In a case where a thickness D11 of the laminated plate material 1 is set to exceed 40 mm, an upper limit of each of widths d11 to d18 of the tops of the wood blocks 11 to 18 constituting the laminated plate material 1 is set to 40 mm or less. The reason is that in the case where the thickness D11 of the laminated plate material 1 exceeds 40 mm, when any of the widths d11 to d18 of the wood blocks 11 to 18 exceeds 40 mm, the blocks are not sufficiently impregnated with the coloring agent in a coloring stage, and uncolored portions eventually remain on the top of the laminated plate material 1 in the existing technology. However, in future, there is a sufficient prospect of development of a technology by adjustment of a pressure or a temperature during the impregnation with the coloring agent or by investigation of components of the coloring agent or the solvent and the like in which even the plate material having a width exceeding 40 mm is sufficiently impregnated with the coloring agent. Therefore, restrictions on the existing technology only have been described above. That is, in future, there is a sufficient possibility that the laminated plate material 1 is usable even if the thickness D11 or each of the widths d11 to d18 of the wood blocks 11 to 18 exceeds 40 mm. It is to be noted that a lower limit of the thickness D11 of the laminated plate material 1 is about 0.2 mm which is a limit with which the wood blocks 11 to 18 can be lumbered (or sliced), but the thickness D11 needs to be about 3 to 5 mm at minimum, considering that the sides of the wood blocks 11 to 18 are bonded to one another. It is to be noted that D12 denotes a width of the laminated plate material 1, and this width D12 is equal to a total of the widths d11 to d18. Moreover, D13 denotes a length of the laminated plate material 1.

In this manner, there is obtained the natural-texture laminated plate material 1 (see FIG. 6) having such a natural appearance that the winter grains are deeply colored and the summer grains are lightly colored. In a case where the wood blocks 11 to 18 are colored, when a black-based pigment or dyestuff is used in the coloring agent, the laminated plate material 1 has a texture closely akin to that of a plate material lumbered from a black natural large-diameter tree such as ebony. When a red-based pigment or dyestuff is used in the coloring agent, the laminated plate material has a texture closely akin to that of a plate material lumbered from a red-based natural large-diameter tree such as red sandalwood. When a brown-based pigment or dyestuff is used in the coloring agent, the laminated plate material has a texture closely akin to that of a plate material lumbered from a brown-based natural large-diameter tree such as cheek. When the color of the pigment or the dyestuff is adjusted in this manner, the textures of various natural large-diameter trees can be reproduced.

That is, speeds at which the pigment or the dyestuff as the coloring agent penetrates into the winter grains w and the summer grains s (see FIG. 15) are different. Therefore, by use of a difference of this penetrating speed, the blocks are removed from the solution of the coloring agent in a state in which the winter grains w are completely colored and the summer grains s are not completely colored. Then, the blocks are dried. It is to be noted that the drying may be performed by any method. Usually, the laminated plate material 1 is sandwiched between sponge rollers (not shown) to squeeze out superfluous coloring agent, and thereafter natural or hot-air drying is performed.

It is to be noted that in a case where the texture of a white-based natural large-diameter tree such as maple is reproduced using a wood such as a rubber having a certain degree of strong color as a raw material, the wood blocks 11 to 18 are immersed into a solution of a decoloring agent, decolored, and dried before the wood blocks 11 to 18 are colored. Thereafter, the blocks are colored using a coloring agent (slightly yellowish color) having such a color that can reproduce a lightly yellowish white color of the maple. That is, in a case where the color of the wood for use as the raw material is deeper than that of the targeted natural large-diameter tree, a decoloring step is inserted before a coloring step. This respect is common to any other embodiment described later.

As an example, there will be specifically described steps of manufacturing a laminated plate material having a texture similar to that of ebony by use of a paulownia wood. First, the paulownia wood was lumbered to obtain the plurality of rectangular parallelepiped wood blocks 11 to 18 (see FIG. 1) having faces on which the straight grains appeared in the longitudinal direction. Next, these wood blocks 11 to 18 were disposed in a pressure tight container (not shown), and a pressure in the pressure tight container was reduced to obtain a substantial vacuum state. After the container was retained for about five hours in this state, the solution (not shown) of the coloring agent was injected into the container to obtain a state in which the whole laminated plate material 1 was immersed into the solution of the coloring agent. The solution of the coloring agent is an aqueous solution containing 3 to 5 wt % of a black pigment, but, a black dye is of course usable. Depending on the type of the pigment or the dyestuff, various solvents such as methyl alcohol and acetone may be used in addition to water. Furthermore, phenol, casein, urethane or the like may be added as a color fixing agent. A reason why the pressure in the pressure tight container is reduced is to remove a water content contained in the laminated plate material 1. If much water content remains, permeability of the pigment or the dyestuff deteriorates. Therefore, it is broadly known that such treatment is performed as a preliminary step for the coloring.

After injecting the solution of the coloring agent, the pressure in the pressure tight container was returned to normal pressure (1 atm). Furthermore, the container was pressurized under 7 atms, and retained for five hours. The pressure in the pressure tight container was again returned to normal pressure (1 atm), and the wood blocks 11 to 18 were removed from the pressure tight container. The removed wood blocks 11 to 18 were sandwiched between the sponge rollers (not shown), and the superfluous water content was squeezed out. Thereafter, the blocks were naturally dried to obtain a water content of 15 wt % or less. Moreover, the respective wood blocks were assembled so as to bring to tops the faces on which the straight grains appeared, the adjacent sides or the blocks were bonded to one another with an agent, and there was obtained a laminated plate material 1 (see FIG. 6) having a thickness (D11) of 100 mm, a width (D12) of 320 mm, and a length (D13) of 1000 mm.

As a result, it was possible to obtain the laminated plate material 1 having a texture closely akin to that of a plate material obtained from a large-diameter tree such as ebony. That is, the pigments completely penetrates into the winter grains w to substantially blacken the winter grains w, and the summer grains s are partially colored in light black. Such texture is a texture itself of the plate material obtained from a large-diameter tree such as ebony (refer to FIG. 15 for details of the colored state) It is to be noted that the texture mentioned herein refers to an apparent state generally obtained from the whole color, grain shapes, a difference of a colored situation between the winter grains w and the summer grains s and the like.

It is to be noted that a reason why the container is pressurized before solution of the coloring agent is injected is to promote the penetration of the pigment or the dyestuff into the wood blocks 11 to 18. In this case, time required for the coloring differs between the penetration at normal temperature as described above and the penetration in a heated state. Such method of pressurizing or heating the container to promote the penetration of the pigment or the dyestuff is broadly performed.

In this case, when the impregnating with the solution of the coloring agent is excessively performed, both the winter grains w and the summer grains s are completely colored, and a state of a wood block 100 shown in FIG. 16 is brought about. There is a type of tree having a color in its material, but there does not exist in the natural world any type of tree whose winter grains w and summer grains s are colored without any distinction as shown in FIG. 16. Therefore, in such state, there is obtained the laminated plate material 100 having an impression far different from the natural texture. However, it has been heretofore usually recognized that such colored state of the wood, that is, a state in which both the winter grains w and the summer grains s are completely colored is a finished state.

On the contrary, in the method of Embodiment 1, the winter grains are deeply colored, and the summer grains are lightly colored. Therefore, this difference between the colored states produces a texture like a natural large-diameter tree grain texture. A similarity in appearance is produced to such an extent that even a specialist cannot tell the difference from a distance. The laminated plate material 1 is constituted of the wood blocks 11 to 18, but the original wood blocks 11 to 18 are not necessarily sampled from adjacent portions of the same tree. Even if the tree type is the same, individuals are usually sampled from various portions. Therefore, even if the wood blocks 11 to 18 are simultaneously colored, the colored states are not constant, and exhibit subtle differences. Moreover, this subtle difference (so-called dye unevenness) is reflected more naturally in human eyes.

That is, when the wood blocks are combined to obtain the laminated material, and the material is colored, one object is to obtain a plate material having a large width from a small-diameter tree as if it were sampled from the large-diameter tree, but there is also produced an effect that fluctuations of the individual wood blocks emphasize the natural texture of the colored material. Moreover, this respect also applies to Embodiments 2 to 9 described below.

### Embodiment 2

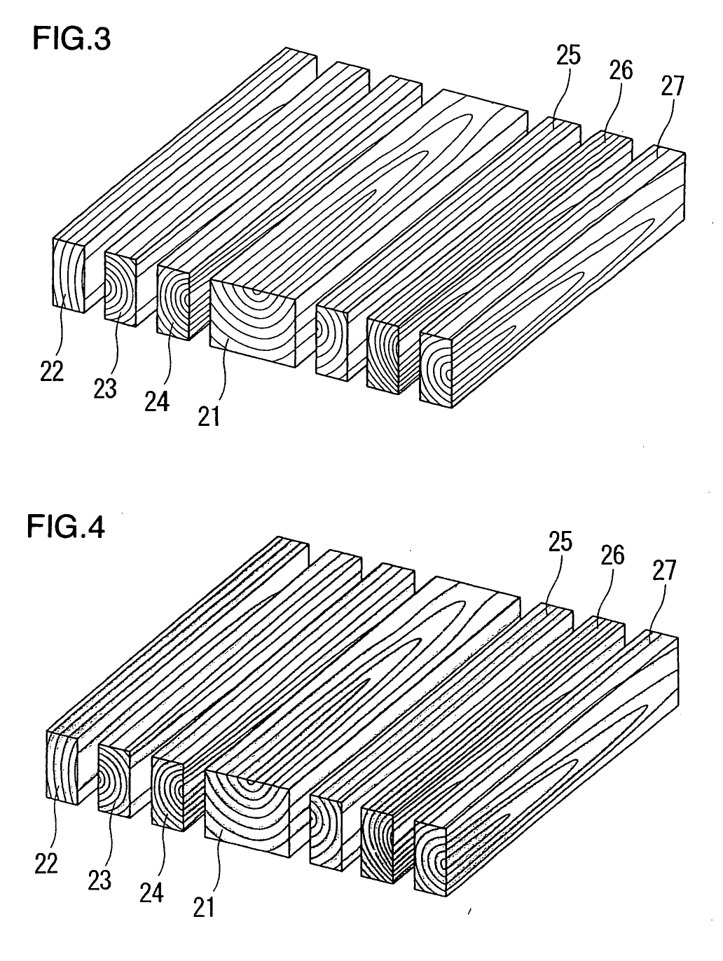

As shown in FIG. 3, there is lumbered a wood which can be cyclically produced in a short cycle in an artificial forest of paulownia, poplar, Radiata pine, whitewood, rubber or the like to obtain a plurality of rectangular parallelepiped wood blocks 21 to 27 having faces on which straight grains appear in a longitudinal direction. Next, the wood blocks 21 to 27 are immersed into a solution (not shown) of a coloring agent dissolved and liquefied in a solvent. The blocks are removed from the solution of the coloring agent in a stage in which winter grains are completely colored and summer grains are being colored. Moreover, the wood blocks 21 to 27 removed from the solution of the coloring agent are dried to obtain natural-texture wood blocks 21 to 27 having natural appearances in which the winter grains are deeply colored and the summer grains are lightly colored (see FIG. 4).

Next, the wood blocks are assembled so as to bring to a top a face of the only wood block 21 on which flat grains appear and bring to tops the faces of the remaining wood blocks 22 to 27 on which the straight grains appear. Adjacent sides of the blocks are bonded to one another with an adhesive, and a laminated plate material 2 (see FIG. 8) is obtained. In this case, when the wood block 21 on whose top the flat grains appear is positioned substantially in the center, the whole grains appearing on the top of the laminated plate material 2 are easily visually recognized as natural flat grains. A texture of the laminated plate material 2 is similar to that of a wood block 10 shown in an enlarged view of FIG. 15. An appearance of the laminated plate material 2 is closely akin to that of a plate material lumbered from a natural large-diameter tree such as ebony, red sandalwood, Chinese quince, cheek, maple, ash, or oak owing to a color of the coloring agent.

It is to be noted that in a case where a thickness D21 of the laminated plate material 2 is set to exceed 40 mm, an upper limit of each of widths d21 to d27 of the tops of the wood blocks 21 to 27 constituting the laminated plate material 2 is set to 40 mm or less. The reason is similar to the reason for the restrictions on the numeric values of the widths d11 to d18 of the wood blocks 11 to 18 in Embodiment 1. It is to be noted that when the width d21 of the wood block 21 is set to be large to a certain degree as shown in FIG. 8, the flat grains of the top of the laminated plate material 2 seem to be more natural.

It is to be noted that a lower limit of the thickness D21 of the laminated plate material 2 is about 0.2 mm which is a limit with which the wood blocks 21 to 27 can be lumbered (or sliced), but the thickness D21 needs to be about 3 to 5 mm at minimum, considering that the sides of the wood blocks 21 to 27 are bonded to one another. It is to be noted that D22 denotes a width of the laminated plate material 2, and a width D22 is a total of the widths d21 to d27. Moreover, D23 denotes a length of the laminated plate material 2.

### Embodiment 3

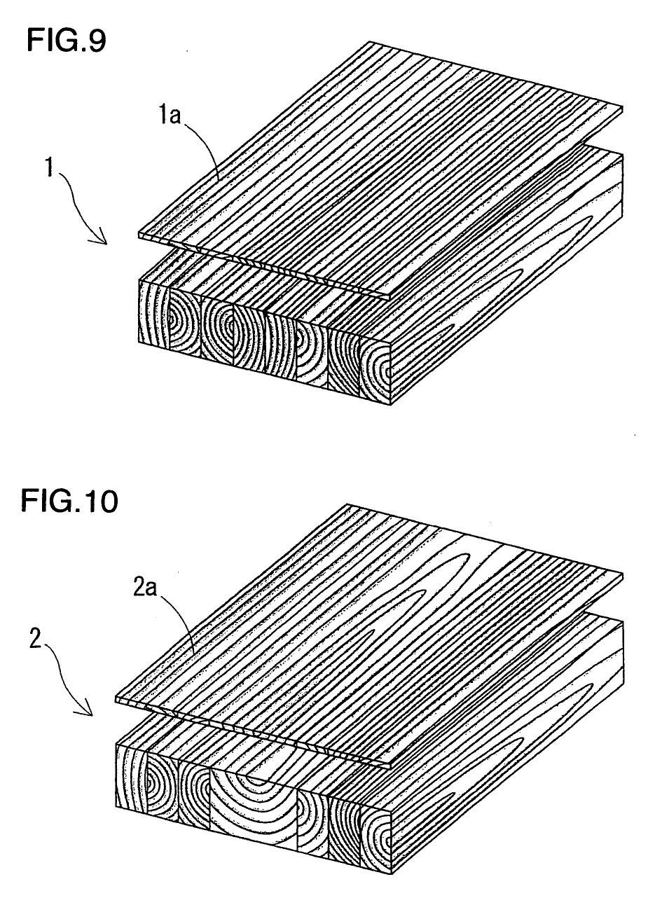

A natural-texture laminated plate material 1 obtained in Embodiment 1 is sliced or lumbered in parallel with a top of the material as shown in FIG. 9 to obtain a laminated plate material 1a of a single ply having a comparatively small thickness (0.2 mm to about several millimeters) and straight grains. The laminated plate material 1a is a natural-texture laminated plate material having a natural appearance in which winter grains are deeply colored and summer grains are lightly colored. When the slicing or the lumbering is repeated in this manner, it is possible to obtain a plurality of straight-grain single-ply plate materials having a texture similar to that of the laminated plate material 1a. The slicing or the lumbering can be continued as long as it is possible to retain the natural appearance in which the winter grains are deeply colored and the summer grains are lightly colored. It is to be noted that, needless to say, a necessary drying degree differs between the slicing and the lumbering (in general, even the inside of the material is preferably dried during the lumbering, but the whole material preferably becomes wet during the slicing). This respect is a fact known to a person skilled in the art, and is not a main part of the present invention. Therefore, the respect is not described in detail.

### Embodiment 4

A natural-texture laminated plate material 2 obtained in Embodiment 2 is sliced or lumbered in parallel with a top of the material as shown in FIG. 10 to obtain a laminated plate material 2a of a single ply having a comparatively small thickness (0.2 mm to about several millimeters). The whole grains seem to be flat grains. The laminated plate material 2a is a natural-texture laminated plate material having a natural appearance in which winter grains are deeply colored and summer grains are lightly colored. When the slicing is repeated in this manner, it is possible to obtain a plurality of single-ply plate materials whose texture is similar to that of the laminated plate material 2a. The whole grains seem to be flat grains. The slicing or the lumbering can be continued as long as it is possible to retain the natural appearance in which the winter grains are deeply colored and the summer grains are lightly colored.

### Embodiment 5

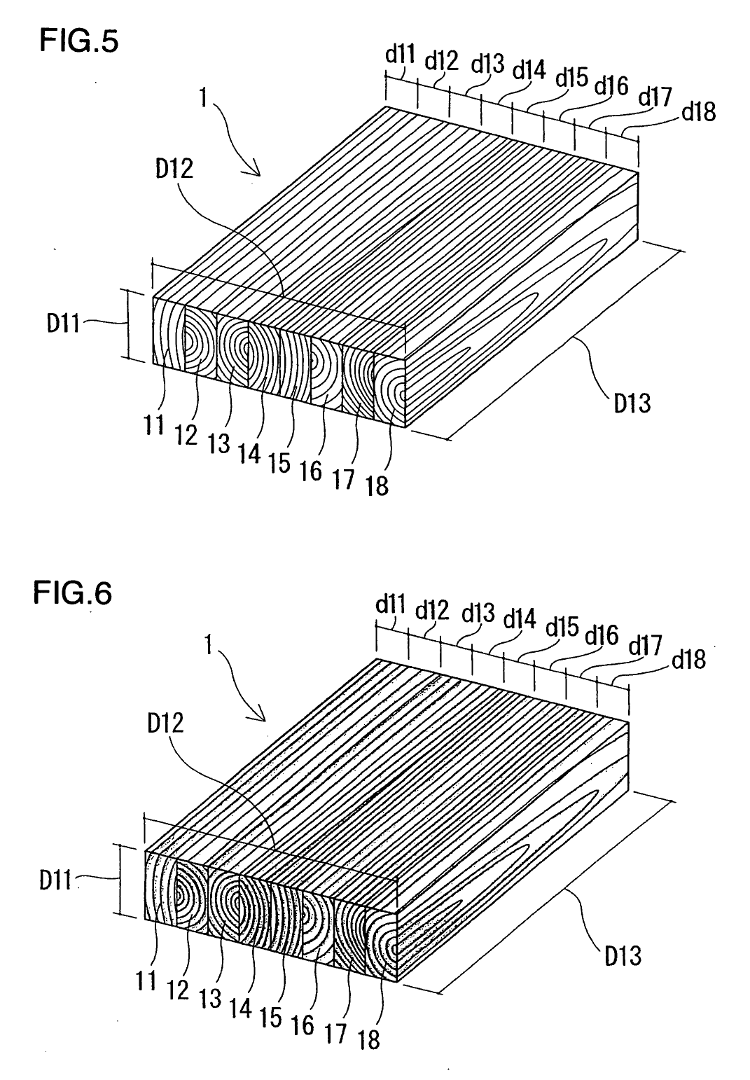

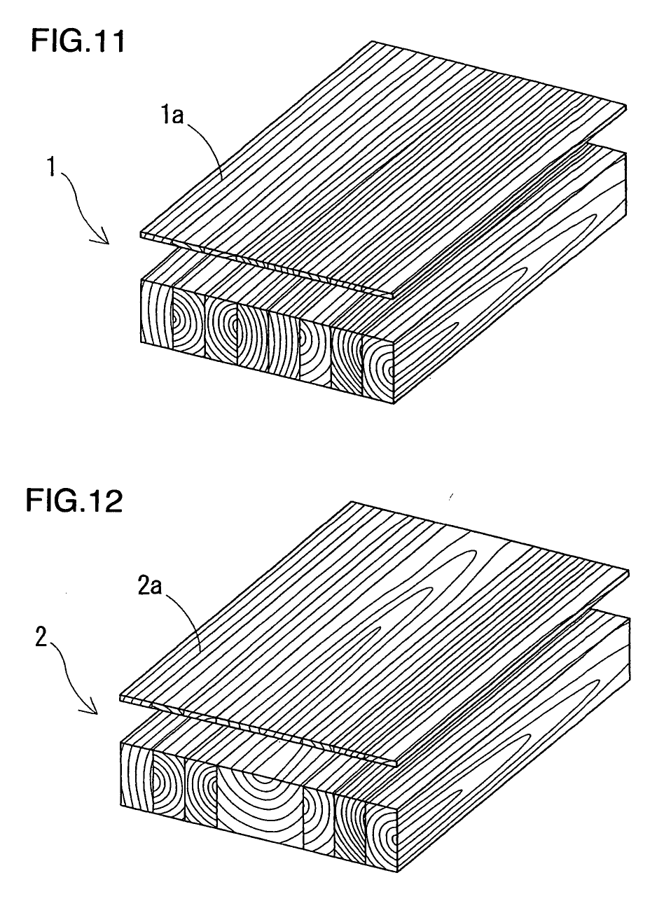

After the wood blocks 11 to 18 shown in FIG. 1 are obtained as above-mentioned with reference to Embodiment 1, the respective wood blocks 11 to 18 are assembled so as to bring, to tops, faces of the respective wood blocks on which straight grains appear, adjacent sides of the blocks are bonded to one another with an adhesive, thereby an uncolored laminated plate material 1 is obtained (see FIG. 5). Next, as shown in FIG. 11, this uncolored laminated plate material 1 is sliced or lumbered in parallel with the top of the material to obtain a straight-grain single-ply laminated plate material 1a having a comparatively small thickness (0.2 mm to about several millimeters). Furthermore, the laminated plate material 1a is immersed into a solution (not shown) of a coloring agent dissolved and liquefied in a solvent, and the material is removed from the solution of the coloring agent in a stage in which winter grains are completely colored and summer grains are being colored. Moreover, the laminated plate material 1a removed from the solution of the coloring agent is dried to obtain the natural-texture laminated plate material 1a having a natural appearance in which the winter grains are deeply colored and the summer grains are lightly colored. In this case, a texture of the laminated plate material 1a is similar to that of a wood block 10 shown in an enlarged view of FIG. 15. An appearance of the laminated plate material 1a is closely akin to that of a plate material lumbered from a natural large-diameter tree such as ebony, red sandalwood, Chinese quince, cheek, maple, ash, or oak. It is to be noted that restrictions on numeric values of widths d11 to d18 of the wood blocks 11 to 18 constituting a laminated plate material 1 and a thickness D11 of the laminated plate material 1 are similar to those of Embodiment 1.

As an example, a paulownia wood was lumbered to obtain the plurality of rectangular parallelepiped wood blocks 11 to 18 (see FIG. 1) having faces on which the straight grains appeared in the longitudinal direction. Next, these wood blocks 11 to 18 were assembled so as to bring to the tops the faces of the respective wood blocks on which the straight grains appeared, the adjacent sides of the blocks were bonded to one another with an adhesive, whereby the laminated plate material 1 (see FIG. 5) was obtained. As to dimensions of the laminated plate material 1, a thickness D11 was set to 100 mm, a width D12 was set to 320 mm, and a length D13 was set to 1000 mm. Furthermore, as shown in FIG. 11, this laminated plate material 1 was sliced in parallel with the top to obtain a single-ply laminated plate material 1a having a thickness of 0.5 mm, a width of 320 mm, and a length of 1000 mm.

Next, this laminated plate material 1a was immersed into a solution (not shown) of a coloring agent containing 3 to 5% of black pigment for about seven minutes. Thereafter, the material 1a was removed from the solution of the coloring agent, and sandwiched between sponge rollers (not shown) to squeeze out a superfluous water content. Subsequently, the material was naturally dried, and a water content was set to 15 wt % or less. As a result, it was possible to obtain a single-ply laminated plate material 1a whose texture was closely akin to that of a plate material obtained from a large-diameter tree such as ebony. It is to be noted that all of the steps were performed under normal pressure (1 atm) at normal temperature (20° C.).

### Embodiment 6

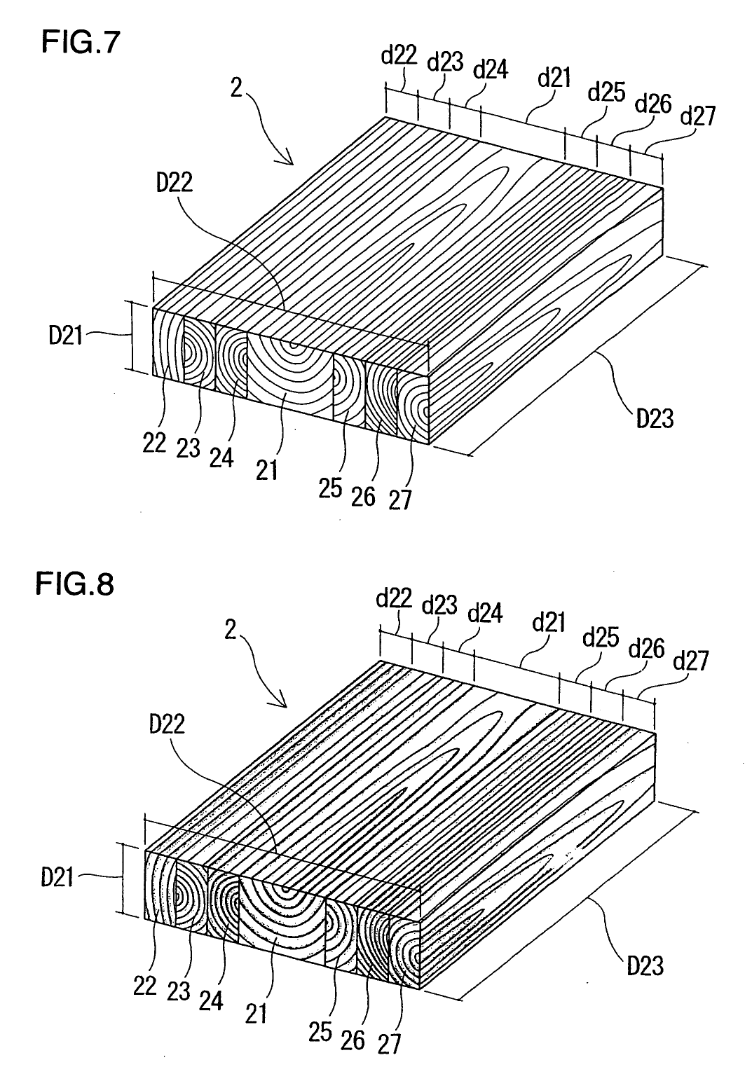

After the wood blocks 21 to 27 shown in FIG. 3 are obtained as described above with reference to Embodiment 2, the wood blocks 21 to 27 are assembled so as to bring, to a top, a face of the only wood block 21 on which flat grains appear in a longitudinal direction and bring, to tops, faces of the remaining wood blocks 22 to 27 on which straight grains appear, adjacent sides of the blocks are bonded to one another with an adhesive, whereby an uncolored laminated plate material 2 is obtained (see FIG. 7). Next, as shown in FIG. 12, this uncolored laminated plate material 2 is sliced or lumbered in parallel with the top of the material to obtain a single-ply laminated plate material 2a having a comparatively small thickness (0.2 mm to about several millimeters). The whole grains of the material 2a seem to be flat grains. Furthermore, the laminated plate material 2a is immersed into a solution (not shown) of a coloring agent dissolved and liquefied in a solvent, and the material is removed from the solution of the coloring agent in a stage in which winter grains are completely colored and summer grains are being colored. Moreover, the laminated plate material 2a removed from the solution of the coloring agent is dried to obtain the natural-texture laminated plate material 2a having a natural appearance in which the winter grains are deeply colored and the summer grains are lightly colored. In this case, a texture of the laminated plate material 2a is similar to that of a wood block 10 shown in an enlarged view of FIG. 15. An appearance of the laminated plate material 2a is closely akin to that of a plate material lumbered from a natural large-diameter tree such as ebony, red sandalwood, Chinese quince, cheek, maple, ash, or oak owing to a color of the coloring agent. It is to be noted that restrictions on numeric values of widths d21 to d27 of the wood blocks 21 to 27 constituting a laminated plate material 2 and a thickness D21 of the laminated plate material 2 are similar to those of Embodiment 2.

### Embodiment 7

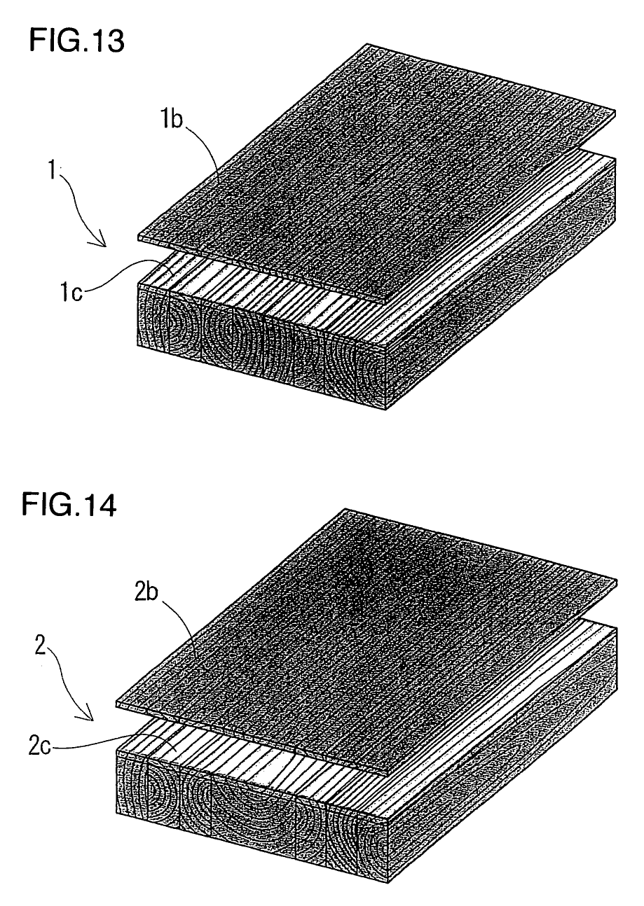

After the wood blocks 11 to 18 shown in FIG. 1 are obtained as above-mentioned with reference to Embodiment 1, the wood blocks 11 to 18 are immersed in a solution (not shown) of a coloring agent dissolved and liquefied in a solvent. The blocks are removed from the solution of the coloring agent in a stage in which both winter grains and summer grains are homogeneously colored, and the blocks are dried. Thereafter, the wood blocks 11 to 18 are assembled so as to bring, to tops, faces of the respective wood blocks on which straight grains appear, and layers in which both the winter and summer grains are completely colored are peeled from adjacent sides of the blocks. Subsequently, the adjacent sides are bonded to one another with an adhesive, and a laminated plate material 1 is obtained in which both the winter and summer grains are homogeneously colored. Next, as shown in FIG. 13, the top of the laminated plate material 1 is peeled in parallel with the top to remove a laminated plate material 1b from the surface of the material. Then, there appear grains having natural appearances in which winter grains are deeply colored and the summer grains are lightly colored. Therefore, the material is further sliced or lumbered to obtain a natural-texture single-ply laminated plate material 1c having a natural appearance in which the winter grains are deeply colored and the summer grains are lightly colored.

If both of the winter and summer grains of the laminated plate material 1c are still homogeneously colored, the material is further sliced until there appear grains having natural appearances in which the winter grains are deeply colored and the summer grains are lightly colored. It is to be noted that the winter and summer grains are homogeneously colored in opposite sides and in opposite butt ends of the laminated plate material 1c. Therefore, by removing these sides and ends, the whole material has a natural appearance in which the winter grains are deeply colored and the summer grains are lightly colored.

### Embodiment 8

After the wood blocks 21 to 27 shown in FIG. 3 are obtained as above-described with reference to Embodiment 2, the wood blocks 21 to 27 are immersed in a solution (not shown) of a coloring agent dissolved and liquefied in a solvent. The blocks are removed from the solution of the coloring agent in a stage in which both winter grains and summer grains are homogeneously colored, and the blocks are dried. Thereafter, the wood blocks 21 to 27 are assembled so as to bring, to a top, a face of the only wood block 21 on which flat grains appear in a longitudinal direction and bring, to tops, faces of the remaining wood blocks 22 to 27 on which straight grains appear, and layers in which both the winter and summer grains are completely colored are peeled from adjacent sides of the blocks. Subsequently, the adjacent sides are bonded to one another with an adhesive, and a laminated plate material 2 is obtained in which both the winter and summer grains are homogeneously colored. Next, as shown in FIG. 14, the top of the laminated plate material 2 is peeled in parallel with the top to remove a laminated plate material 2b from the surface of the material 2. Then, there appear grains having natural appearances in which winter grains are deeply colored and the summer grains are lightly colored. Therefore, the material is further sliced or lumbered to obtain a natural-texture single-ply laminated plate material 2c having a natural appearance in which the winter grains are deeply colored and the summer grains are lightly colored.

If both of the winter and summer grains of the laminated plate material 2c are still homogeneously colored, the material is further peeled until there appear grains having natural appearances in which the winter grains are deeply colored and the summer grains are lightly colored. It is to be noted that the winter and summer grains are homogeneously colored in opposite sides and in opposite butt ends of the laminated plate material 2c. Therefore, by removing these sides and ends, the whole material has a natural appearance in which the winter grains are deeply colored and the summer grains are lightly colored.

### Embodiment 9

In the method of manufacturing the laminated plate material having the natural texture in Embodiments 1 to 8, the coloring agent was blended with a boric acid, an inorganic phosphoric acid or the like as an incombustible agent, whereby incombustible laminated plate materials 1, 2, 1a, 1c, 2a, and 2c having natural textures were obtained.

The present invention relates to a method of manufacturing a laminated plate material having a natural texture to manufacture the laminated plate material having the natural texture similar to that of a plate material lumbered from a natural large-diameter tree having a scarcity value, such as ebony, red sandalwood, Chinese quince, cheek, maple, ash, or oak by use of a wood which can be cyclically produced in a short cycle in an artificial forest of paulownia, poplar, Radiata pine, whitewood, rubber or the like. The present invention also relates to a natural-texture laminated plate material manufactured by the method. Therefore, it is possible to use a laminated plate material having a texture of the natural large-diameter tree which provides a feeling of luxury, while contributing to protection of global environments and protection of resources. Therefore, the present invention can be applied to many fields ranging from buildings, fixtures, and furniture to daily goods and toys, and various developments are possible.

It is to be noted that in the solution means 1 to 4 and 7 to 10 of the present invention, there is a first step of obtaining a plurality of rectangular parallelepiped wood blocks having faces on which straight grains appear in a longitudinal direction. The wood blocks are individually colored before assembled, but this order may be reversed. That is to say, a method may be used in which first the wood blocks are assembled to form a laminated plate material, and the whole laminated plate material is immersed into the solution of the coloring agent to color the material. However, in this case, it is presumed that a large-scale container is required as a pressure adjusting container for immersing the laminated plate material into the solution of the coloring agent. Therefore, this method is said to be appropriately selectable depending on industrial applicability. It is to be noted that in the methods of the solution means 5 and 6, the laminated plate material is obtained before colored, the material is sliced or lumbered to obtain a thin laminated plate material, and the material is colored. Therefore, a container may have a usual size in which the whole material is immersed, and the pressure adjusting container is not required.

The embodiments have been described above, but the present invention is not limited to the embodiments, and it is apparent for a person skilled in the art that various alternations and modifications can be performed within the spirits of the present invention as claimed in the appended claims.

1. A method of manufacturing a laminated plate material having a natural texture, comprising the steps of:
lumbering a wood which is cyclically produceable in an artificial forest to obtain a plurality of rectangular parallelepiped wood blocks having faces on which straight grains appear in a longitudinal direction;
immersing the respective wood blocks obtained in the above step into a solution of a coloring agent dissolved and liquefied in a solvent;
removing the respective immersed wood blocks from the solution of the coloring agent in a stage in which winter grains are completely colored and summer grains are in process of coloring; and
assembling the respective wood blocks removed from the solution of the coloring agent so as to bring to tops the faces on which the straight grains appear, bonding adjacent sides of the blocks to one another with an adhesive, whereby the natural-texture laminated plate material having such a natural appearance that the winter grains are deeply colored and the summer grains are lightly colored is obtained.

2. A method of manufacturing a laminated plate material having a natural texture, comprising the steps of:
lumbering a wood which is cyclically produceable in an artificial forest to obtain a plurality of rectangular parallelepiped wood blocks having faces on which straight grains appear in a longitudinal direction;
immersing the respective wood blocks obtained in the above step into a solution of a coloring agent dissolved and liquefied in a solvent;
removing the respective immersed wood blocks from the solution of the coloring agent in a stage in which winter grains are completely colored and summer grains are in process of coloring; and
assembling the respective wood blocks removed from the solution of the coloring agent so as to bring to a top a face of one of the wood blocks on which flat grains appear and bring to tops the faces of the remaining wood blocks on which the straight grains appear, bonding adjacent sides of the blocks to one another with an adhesive, whereby the natural-texture laminated plate material having such a natural appearance that the winter grains are deeply colored and the summer grains are lightly colored is obtained.

3. A method of manufacturing a laminated plate material having a natural texture, comprising the steps of:
lumbering a wood which is cyclically produceable in an artificial forest to obtain a plurality of rectangular parallelepiped wood blocks having faces on which straight grains appear in a longitudinal direction;
immersing the respective wood blocks obtained in the above step into a solution of a coloring agent dissolved and liquefied in a solvent;
removing the respective immersed wood blocks from the solution of the coloring agent in a stage in which winter grains are completely colored and summer grains are in process of coloring;
assembling the respective wood blocks removed from the solution of the coloring agent so as to bring to tops the faces on which the straight grains appear, bonding adjacent sides of the blocks to one another with an adhesive, and obtaining the natural-texture laminated plate material having such a natural appearance that the winter grains are deeply colored and the summer grains are lightly colored; and
slicing or lumbering the resultant natural-texture laminated plate material in parallel with the top of the material to obtain a plurality of natural-texture laminated plate materials having such the natural appearance that the winter grains are deeply colored and the summer grains are lightly colored.

4. A method of manufacturing a laminated plate material having a natural texture, comprising the steps of:
lumbering a wood which is cyclically produceable in an artificial forest to obtain a plurality of rectangular parallelepiped wood blocks having faces on which straight grains appear in a longitudinal direction;
immersing the respective wood blocks obtained in the above step into a solution of a coloring agent dissolved and liquefied in a solvent;
removing the respective immersed wood blocks from the solution of the coloring agent in a stage in which winter grains are completely colored and summer grains are in process of coloring;
assembling the respective wood blocks removed from the solution of the coloring agent so as to bring to a top a face of one of the wood blocks on which flat grains appear and bring to tops the faces of the remaining wood blocks on which the straight grains appear, bonding adjacent sides of the blocks to one another with an adhesive to obtain the natural-texture laminated plate material having such a natural appearance that the winter grains are deeply colored and the summer grains are lightly colored; and
slicing or lumbering the resultant natural-texture laminated plate material in parallel with the top of the material to obtain a plurality of natural-texture laminated plate materials having such the natural appearance that the winter grains are deeply colored and the summer grains are lightly colored.

5. A method of manufacturing a laminated plate material having a natural texture, comprising the steps of:
lumbering a wood which is cyclically produceable in an artificial forest to obtain a plurality of rectangular parallelepiped wood blocks having faces on which straight grains appear in a longitudinal direction;
assembling the respective wood blocks obtained in the above step so as to bring to tops the faces on which the straight grains appear, bonding adjacent sides of the blocks to one another with an adhesive, and obtaining a laminated plate material;
slicing or lumbering the laminated plate material obtained in the second step in parallel with the top of the material to obtain a plurality of laminated plate materials;
immersing the respective laminated plate materials obtained in the third step into a solution of a coloring agent dissolved and liquefied in a solvent; and
removing the respective immersed laminated plate materials from the solution of the coloring agent in a stage in which winter grains are completely colored and summer grains are in process of coloring, whereby the natural-texture laminated plate material having such natural appearances that the winter grains are deeply colored and the summer grains are lightly colored is obtained.

6. A method of manufacturing a laminated plate material having a natural texture, comprising the steps of:
lumbering a wood which is cyclically produceable in an artificial forest to obtain a plurality of rectangular parallelepiped wood blocks having faces on which straight grains appear in a longitudinal direction;
assembling the respective wood blocks obtained in the above step so as to bring to a top a face of one of the wood blocks on which flat grains appear and bring to tops the faces of the remaining wood blocks on which the straight grains appear, bonding adjacent sides of the blocks to one another with an adhesive, and obtaining a laminated plate material;
slicing or lumbering the laminated plate material obtained in the second step in parallel with the top of the material to obtain a plurality of laminated plate materials;
immersing the respective laminated plate materials obtained in the third step into a solution of a coloring agent dissolved and liquefied in a solvent; and
removing the respective immersed laminated plate materials from the solution of the coloring agent in a stage in which winter grains are completely colored and summer grains are in process of coloring, whereby natural-texture laminated plate material having such natural appearances that the winter grains are deeply colored and the summer grains are lightly colored is obtained.

7. A method of manufacturing a laminated plate material having a natural texture, comprising the steps of:
lumbering a wood which is cyclically produceable in an artificial forest to obtain a plurality of rectangular parallelepiped wood blocks having faces on which straight grains appear in a longitudinal direction;
immersing the respective wood blocks obtained in the above step into a solution of a coloring agent dissolved and liquefied in a solvent;
removing the respective immersed wood blocks from the solution of the coloring agent in a stage in which both of winter and summer grains are completely colored;
assembling the respective removed wood blocks so as to bring to tops the faces of the respective wood blocks on which the straight grains appear, peeling layers in which both of the winter and summer grains are completely colored from adjacent sides of the blocks and thereafter bonding the adjacent sides to one another with an adhesive to obtain a laminated plate material in which both of the winter and summer grains are completely colored; and
peeling the surface of the laminated plate material obtained in the fourth step until a face appears on which the winter grains are completely colored and the summer grains are being colored, whereby the natural-texture laminated plate material having such a natural appearance that the winter grains are deeply colored and the summer grains are lightly colored is obtained.

8. A method of manufacturing a laminated plate material having a natural texture, comprising the steps of:
lumbering a wood which is cyclically produceable in an artificial forest to obtain a plurality of rectangular parallelepiped wood blocks having faces on which straight grains appear in a longitudinal direction;
immersing the respective wood blocks obtained in the above step into a solution of a coloring agent dissolved and liquefied in a solvent;
removing the respective immersed wood blocks from the solution of the coloring agent in a stage in which both of winter and summer grains are completely colored;
assembling the respective removed wood blocks so as to bring to a top a face of one of the wood blocks on which flat grains appear and bring to tops the faces of the remaining wood blocks on which the straight grains appear, peeling layers in which both of the winter and summer grains are completely colored from adjacent sides of the blocks before bonding the adjacent sides to one another to obtain a laminated plate material; and
peeling the surface of the laminated plate material obtained in the fourth step until a face appears on which the winter grains are completely colored and the summer grains are being colored, whereby the natural-texture laminated plate material having such a natural appearance that the winter grains are deeply colored and the summer grains are lightly colored is obtained.

9. The method of manufacturing the laminated plate material having the natural texture according to any one of claims 1 to 8, wherein the solution of the coloring agent is blended with an incombustible agent.

10. A natural-texture laminated plate material manufactured by the method of manufacturing the laminated plate material having the natural texture according to any one of claims 1 to 8.

11. A natural-texture laminated plate material manufactured by the method of manufacturing the laminated plate material having the natural texture according to claim 9.
